(19) United States
(12) Patent Application Publication
(10) Pub. No.: US 2024/0414257 A1
(43) Pub. Date: Dec. 12, 2024

(54) Smart Intercom Device

(71) Applicant: Abdelkader Madnoub, Rockville, MD (US)

(72) Inventor: Abdelkader Madnoub, Rockville, MD (US)

(21) Appl. No.: 18/430,781

(22) Filed: Feb. 2, 2024

Related U.S. Application Data
(60) Provisional application No. 63/506,667, filed on Jun. 7, 2023.

(51) Int. Cl. H04M 1/27475; G06K 7/14; G06K 19/06; H04M 11/02

(52) U.S. Cl. CPC H04M 1/27475; G06K 7/1417; G06K 19/06037; H04M 11/025

(57) ABSTRACT

A smart intercom device is disclosed that utilizes scanning stickers and QR codes to communicate with others. Specifically, a visitor uses their smartphone to scan a scanning sticker or QR code at a building, apartment, home, office, etc. The QR code or scanning sticker connects the visitor with a specific person in the building, allowing the person to see who is at the door and communicate with them, as needed. Thus, instead of using a standard intercom system, visitors can scan the appropriate QR code and communicate with a person on the intercom list.

### CROSS-REFERENCE TO RELATED APPLICATION

The present application claims priority to, and the benefit of, U.S. Provisional Application No. 63/506,667, which was filed on Jun. 7, 2023, and is incorporated herein by reference in its entirety.

### FIELD OF THE INVENTION

The present invention relates generally to the field of smart intercom devices. More specifically, the present invention relates to an intercom system that connects to a smartphone. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in smart intercom devices. Generally, people typically carry a smartphone with them daily and do not leave home without it. Further, standard intercom systems can malfunction constantly, and people may miss out on important deliveries and visitors without a proper intercom system. Additionally, without cameras near a door, people may be unaware of who is at the door and risk break-ins.

Furthermore, traditional intercom systems depend upon either a physically installed intercom or a public switched telephone network (PSTN) telephone. These traditional systems are expensive, require difficult installation, and are difficult to upgrade. As such, there is a need for a cheaper, more versatile intercom system. Increasingly, occupants no longer have a PSTN phone.

Accordingly, there is a demand for an improved smart intercom device that prevents visitors from missing deliveries or important visitors at their door. More particularly, there is a demand for a smart intercom device that utilizes scannable QR codes to communicate with people in the office, home, apartment, or other building.

Therefore, there exists a long felt need in the art for a smart intercom device that provides visitors with an intercom system that connects with a smartphone. There is also a long felt need in the art for a smart intercom device that features scanning stickers and QR codes that can be scanned to communicate with people in the office, home, apartment, or other building. Further, there is a long felt need in the art for a smart intercom device that allows visitors to identify who is at the door without risking speaking to strangers or being unaware of a visitor. Moreover, there is a long felt need in the art for a device that prevents people from missing deliveries or important visitors at their door via the smartphone alerts. Further, there is a long felt need in the art for a smart intercom device that allows visitors to bypass the standard intercom system. Finally, there is a long felt need in the art for a smart intercom device that uses a smartphone to reach people inside the building.

The subject matter disclosed and claimed herein, in one embodiment thereof, comprises a smart intercom device. The device is a specialized intercom system that utilizes scanning stickers and QR codes to communicate with others. Specifically, a visitor uses their smartphone to scan a scanning sticker or QR code at a building, apartment, home, office, etc. The QR code or scanning sticker connects the visitor with a specific person in the building, allowing the person to see who is at the door and communicate with them, as needed. Thus, instead of using a standard intercom system, visitors can scan the appropriate QR code and communicate with a person on the intercom list.

In this manner, the smart intercom device of the present invention accomplishes all of the forgoing objectives and provides visitors with a device that utilizes QR cods to communicate with people on an intercom list. The device is a smart intercom that connects with a smartphone. The device prevents people from missing visitors and deliveries.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart intercom device. The device is a specialized intercom system that utilizes scanning stickers and QR codes to communicate with others. Specifically, a visitor uses their smartphone to scan a scanning sticker or QR code at a building, apartment, home, office, etc. The QR code or scanning sticker connects the visitor with a specific occupant in the building, allowing the occupant to know and see who is at the door and communicate with them, as needed. Thus, instead of using a standard intercom system, visitors can scan the appropriate QR code and communicate with an occupant on the intercom list.

The disclosed device and related techniques are directed towards a smart intercom device for a facility. The smart intercom device uses a QR code to facilitate communication between an occupant of the facility and a visitor. The smart intercom device maintains the privacy and safety of the occupant while allowing a visitor to communicate securely with the occupant.

The disclosed device and related techniques provide a solution to the problem of allowing a visitor to communicate securely with an occupant of a facility while maintaining the privacy of the occupant. Other intercom systems may reveal the name of an occupant, a unit number of an occupant, a floor of an occupant, and/or a phone number of an occupant when a visitor is attempting to communicate with the occupant, therefore putting the occupant's privacy at risk. In contrast, the disclosed device and related techniques limit the information associated with an occupant that is made available to a visitor.

In one embodiment, the smart intercom device comprises a QR code corresponding to an intercom list as a whole, or a separate QR code is utilized for each occupant on the intercom list. Thus, each occupant on the intercom list creates a profile on the corresponding software application, which is then linked to an individual QR code. Thus, visitors can contact a specified occupant on the intercom list via their individual QR code.

In one embodiment, a “quick response” code or “QR code” may be a matrix barcode and a type of machine-readable code that contains information (i.e., information pertaining to a specific person's name, address, and phone number). A typical QR code may use four standardized encoding modes (numeric, alphanumeric, byte/binary, and kanji) to efficiently store data.

As explained above, QR codes can encode personal data and other information. A QR code can be used to initiate contact with a specified occupant. Further, two-way communication using QR codes can also improve security.

Specifically, the disclosed device and related techniques may allow a visitor to lookup a unit number or a floor of the occupant without revealing the name of the occupant and/or a phone number of the occupant. Similarly, the disclosed device and related techniques may allow a visitor to enter a name of an occupant without revealing the unit number, floor, and/or phone number of the occupant. The disclosed device and related techniques accomplishes this, in part, through use of a software application and QR code by which the device facilitates communication between the visitor and the occupant.

In one embodiment, the disclosed device further protects the privacy and safety interests of an occupant by optionally requiring that the visitor be within a predetermined boundary before they are permitted to contact the occupant. For example, the disclosed device may require that the visitor be within 5 meters of the facility before they can contact an occupant of the facility through the QR code. The boundary may be set by a manager of the facility. When a visitor makes attempts to contact an occupant, a global positioning system (GPS) unit of the smart device will send a location of the device to the disclosed smart intercom device. The disclosed device determines, based on the received location, whether the visitor device is within the predetermined boundary. If a visitor is too far away (i.e., outside of the predetermined boundary), they may be notified that they are not within the predetermined boundary when attempting to contact an occupant and prevented from contacting the occupant. Similarly, in other embodiments, the disclosed device further protects the privacy and safety interests of the occupant by requiring that the occupant is within a predetermined boundary before a visitor is able to contact them.

In one embodiment, the disclosed device further protects the privacy and safety interests of an occupant by allowing the occupant to choose the method by which they are contacted by the visitor. For example, an occupant may choose to permit a visitor to contact them through a notification or a text message but may prevent contact through a voice call or through a video call. Where contact is made through a voice call or a video call, the visitor will not be provided a phone number of the occupant. However, in some implementations, where contact is made through a voice call or a video call, the occupant may receive the phone number of the visitor or other identifying information of the visitor such as their name.

In one embodiment, the disclosed device further protects the privacy and safety interests of an occupant by allowing the occupant to choose the method by which they (the occupant) request additional information from a visitor. For example, an occupant may choose to initiate a conversation with the visitor to obtain additional information through a notification, a text message, a voice call, or a video call.

In one embodiment, the disclosed device also prevents a visitor from entering a facility or a unit of a facility when an occupant of the facility cannot, or would prefer not to, physically provide access to the visitor.

In one embodiment, the disclosed device eliminates most of the costs associated with a traditional intercom system and reduces the time needed to setup an intercom system. By using a virtual intercom system, there is no need to spend the time and cost installing a physical intercom system in the facility. Such traditional systems are expensive and require difficult installation as numerous wires may need to be run throughout the facility on which the intercom is being installed. The disclosed device removes the need for such traditional systems by using a mobile or software application in communication with a QR code and a visitor's smart device.

In one embodiment, the smart intercom device allows a visitor to contact and communicate with a specified occupant from an intercom list. Specifically, a smart phone of a visitor is used to scan a QR code that is associated with a specified occupant from an intercom list. The QR code then allows the visitor to communicate with the specified occupant. Specifically, the QR code and software application displays on the visitor's smart phone, an interface for contacting the specified occupant. The visitor can then choose how to contact the specified occupant, either calling, messaging, and/or sending an alert in the form of an audible sound or noise. The call, message, or alert is then sent and the visitor is now able to communicate with the specified occupant to determine if they are home and/or can come pick up a package or open the door.

In one embodiment, an apartment, office, home, or other building displays a two dimensional barcode (or QR code) that corresponds to an intercom list. Other types of scannable codes could also be used in the same manner as the QR code. The QR code is uniquely associated with the intercom list. More specifically, the QR code can uniquely identify a specified occupant from the intercom list. One QR code could be linked to the intercom list in general or a separate QR code would be listed for each person on the intercom list. In this manner, by scanning the QR code, a software application executing on a smart phone can retrieve the necessary information for communicating with a specified occupant on the intercom list.

Furthermore, a database of QR codes can be maintained (i.e., on a server system with which a smart phone can communicate). Each of the QR codes in the database can be associated with a unique individual on the intercom list. The database can also store contact information for each of the individuals on the intercom list. In such cases, when a visitor scans a QR code with a smart phone, a software application on the smart phone can access the database to identify whether the QR code is defined in the database. If the QR code is defined in the database, the contact information associated with the QR code can be used to contact the specified occupant on the intercom list.

Additionally, each QR code represents a unique identifier. When the QR code is scanned, the unique identifier for the QR code can be determined and used to query a data structure to obtain the contact information associated with the QR code. Once obtained, the account information can be used to contact the specified occupant on the intercom list.

Furthermore, the present invention enables a visitor to contact someone on an intercom list by simply scanning a QR code that has been associated with the intercom list or more specifically, scanning a QR code that has been associated with a specified occupant from the intercom list. In some embodiments, the present invention can provide a website or other software application where people from the intercom list can input their contact information to receive a QR code that is unique to them and which can be displayed outside their apartment, office, home, or other building for visitors, in lieu of an intercom. Visitors can then contact a specified occupant from the intercom list when visiting or dropping a package off. For example, in response to receiving an occupant's contact information, the software application can generate an association between the contact information and a QR code. The associated QR code can then be provided to the visitor who is trying to contact the specified occupant. For example, the QR code can be displayed outside of or in the lobby of an apartment complex, office, home, or other building, to allow the QR code to be visible to visitors.

In one embodiment, the QR code requests can be timestamped, as well as may specify a unit number of the occupant, a floor of the occupant, or a name of the occupant. Based on the specified information, a centralized computer system searches through the stored occupant information to identify the occupant associated with the visitor's request. Once the occupant is identified, the centralized computer system may pull up additional information associated with the identified occupant that is stored in occupant information of the centralized data storage. This additional information may include, for example, a phone number of the occupant, a name of the occupant, a time period when the occupant accepts requests, a primary means of communication, a secondary means of communication, an indication to not participate in such communications if there is a no-call list, a neighbor who has agreed to receive the occupant's requests when the occupant is not available, an indication that the occupant is away or on vacation, etc. This additional information may be used by the centralized computer system to facilitate communication between the visitor and the occupant.

In one embodiment, the centralized computer system may store information associated with the visitor who made the request. This information may be stored under visitor information within the centralized data storage of the centralized computer system. This information may include, for example, a name of the visitor, a phone number of the visitor, the type of request made (i.e., did the visitor request access to an entrance of a facility), reason for the request (i.e., delivery, social visit, etc.), affiliations (i.e., FedEx employee), etc. This information may be used by the centralized computer system to facilitate communication between the visitor and the occupant.

In one embodiment, the visitor interface generated by the QR code may require that the visitor authenticates themselves. Authentication may include requiring the visitor to enter their name, phone number, reason for visiting, etc. This information may then be provided to the centralized computer system for storage. Once a visitor is authenticated, they may be provided an authorization code by the centralized computer system. When a visitor makes a request to communicate with an occupant, this authorization code may be provided to the occupant device. The occupant device may use the authorization code to access information associated with the visitor, such as, for example, the visitor's name, phone number, and/or reason for visiting.

In one embodiment, an example computer environment includes a mobile computing device which may typically be a smart phone having a camera with which a QR code can be scanned. The smart phone is interconnected via a network with multiple server systems. The server systems can represent the systems where a person's contact information is stored.

The specific manner in which information is transferred is not essential to the invention. The network typically will be the internet although other networks can also be employed. For example, in a typical implementation, the mobile computing device will communicate with one or more of the server systems using a Wi-Fi or cellular (i.e., 4G) connection. Also, although this specification will primarily refer to using a smart phone, any mobile computing device capable of performing the described functionality could also be used (i.e., a tablet).

In another embodiment, a process of creating an association between a QR code and an occupant's contact information is disclosed. An occupant from the intercom list desiring to receive a QR code inputs their contact information in a web page or software application. Contact information can include an occupant's name, address, unit number, and telephone number, as well as any other information necessary to contact the occupant. Additional information can also be input such as the occupant's work location, work title, picture, etc. Such information can be useful for providing an interface such as a visitor interface when a QR code is scanned.

Once the contact information is input to the web page or software application, the contact information can then be sent to a server system. The QR code can then be generated/associated with the contact information. Once the occupant receives the QR code, it can be displayed (i.e., electronically or by printing the QR code) where visitors can view and scan it to gain contact information and to communicate with the specified occupant from the intercom list. Accordingly, a visitor scans the QR code using a smart phone and gains access to an intercom interface on their smart phone. The scanned QR code is then used to retrieve the appropriate contact information. Finally, the contact information is used to initiate communication between the visitor and the specified occupant from the intercom list, that is associated with the scanned QR code.

In one embodiment, the occupant device and visitor device wirelessly communicate with the one or more doors of a facility and of an individual unit. The wireless communication may take place through cellular, Bluetooth, near-field communication (NFC), radio-frequency identification (RFID), and/or Wi-Fi, etc., to allow a visitor access if requested and approved by the occupant.

In one embodiment, once the visitor scans the QR code located on a door of the front entrance via the camera of their smart device, the visitor device is directed to a website or a digital distribution platform to access a software application or a Wi-Fi network that allows a visitor to communicate with an occupant of the facility. In some embodiments, the QR code also allows a visitor to request access to an entrance of a facility.

The occupant device and the visitor device may each be a computing device, i.e., a mobile phone, a smart phone, a personal digital assistant (PDA), a tablet computer, a laptop computer, or a desktop computer, etc.

In yet another embodiment, the smart intercom device comprises a plurality of indicia.

In yet another embodiment, a method of scanning a QR code to communicate with an occupant on an intercom list is disclosed. The method includes the steps of providing a smart intercom device comprising a scannable QR code that is associated with occupants on an intercom list for a specific building, office, home, apartment, etc. The method also comprises scanning a specific QR code via a smart phone. Further, the method comprises contacting a specific occupant on the intercom list via the scanned QR code. Finally, the method comprises communicating with the specified occupant on the intercom list via the smart phone, as needed.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the smart intercom device of the present invention showing an example of an intercom interface on a smartphone in accordance with the disclosed architecture;

FIG. 2 illustrate a front perspective view of the smart intercom device of the present invention showing a list of standard intercom numbers in accordance with the disclosed architecture;

FIG. 3 illustrates a perspective view of one embodiment of the smart intercom device of the present invention showing a standard intercom system in accordance with the disclosed architecture;

FIG. 4 illustrates a perspective view of one embodiment of the smart intercom device of the present invention showing the computer environment for the smart intercom device in accordance with the disclosed architecture;

FIG. 5 illustrates a flowchart of one embodiment of the process of utilizing the smart intercom device in accordance with the disclosed architecture; and

FIG. 6 illustrates a flowchart showing the method of scanning a QR code to communicate with a person on an intercom list in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a smart intercom device that provides visitors with an intercom system that connects with a smartphone. There is also a long felt need in the art for a smart intercom device that features scanning stickers and QR codes that can be scanned to communicate with people in the office, home, apartment, or other building. Further, there is a long felt need in the art for a smart intercom device that allows visitors to identify who is at the door without risking speaking to strangers or being unaware of a visitor. Moreover, there is a long felt need in the art for a device that prevents people from missing deliveries or important visitors at their door via the smartphone alerts. Further, there is a long felt need in the art for a smart intercom device that allows visitors to bypass the standard intercom system. Finally, there is a long felt need in the art for a smart intercom device that uses a smartphone to reach people inside the building.

The present invention, in one exemplary embodiment, is a novel smart intercom device. The device is a specialized intercom system that utilizes scanning stickers and QR codes to communicate with others. Specifically, a visitor uses their smartphone to scan a scanning sticker or QR code at a building, apartment, home, office, etc. The QR code or scanning sticker connects the visitor with a specific person in the building, allowing the person to see who is at the door and communicate with them, as needed. Thus, instead of using a standard intercom system, visitors can scan the appropriate QR code and communicate with a person on the intercom list. The present invention also includes a novel method of scanning a QR code to communicate with a person on an intercom list. The method includes the steps of providing a smart intercom device comprising a scannable QR code that is associated with people on an intercom list for a specific building, office, home, apartment, etc. The method also comprises scanning a specific QR code via a smart phone. Further, the method comprises contacting a specific occupant on the intercom list via the scanned QR code. Finally, the method comprises communicating with the specified occupant on the intercom list via the smart phone, as needed.

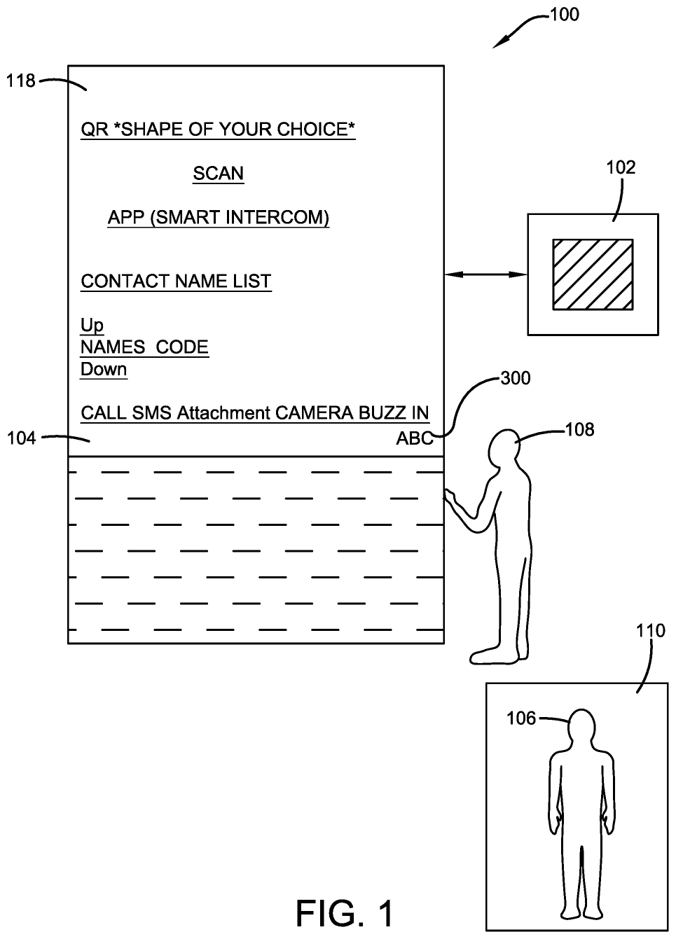

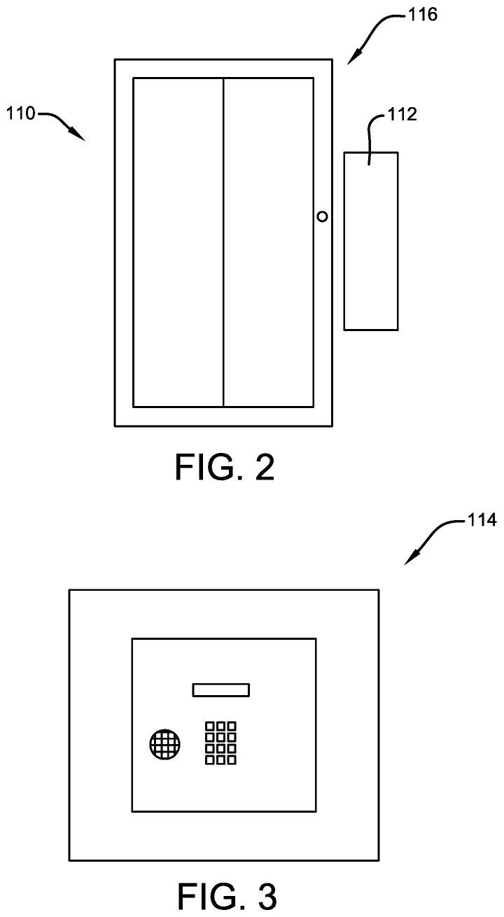

Referring initially to the drawings, FIGS. 1-3 illustrate a perspective view of one embodiment of the smart intercom device 100 of the present invention. In the present embodiment, the smart intercom device 100 is an improved smart intercom device 100 that provides a visitor 108 with a means for communicating with an occupant 106 on an intercom list 116 via a scannable QR code 102. Specifically, a visitor 108 uses their smartphone 104 to scan a scanning sticker or QR code 102 at a building 110, apartment, home, office, etc. The QR code 102 or scanning sticker connects the visitor 108 with a specific occupant 106 in the building 110, allowing the occupant 106 to know and see who is at the door 112 and communicate with them, as needed. Thus, instead of using a standard intercom system 114, visitors 108 can scan the appropriate QR code 102 and communicate with an occupant 106 on the intercom list 116.

Generally, the disclosed device 100 and related techniques are directed towards a smart intercom device 100 for a facility (i.e., building 110). The smart intercom device 100 uses a QR code 102 to facilitate communication between an occupant 106 of the facility 110 and a visitor 108. The smart intercom device 100 maintains the privacy and safety of the occupant 106 while allowing a visitor 108 to communicate securely with the occupant 106.

A facility 110 may include, for example, a multi-unit dwelling, an apartment, a house, a townhouse, a condominium, a duplex, other residential facilities, an office, a gated area, other commercial facilities, etc.

A visitor 108 may be a delivery person, a potential client, a client, a potential employee, an employee, a potential work associate, a work associate, a social guest, etc.

The disclosed device 100 and related techniques provide a solution to the problem of allowing a visitor 108 to communicate securely with an occupant 106 of a facility 110 while maintaining the privacy of the occupant 106. Other intercom systems 114 may reveal the name of an occupant 106, a unit number of an occupant 106, a floor of an occupant 106, and/or a phone number of an occupant 106 when a visitor 108 is attempting to communicate with the occupant 106, therefore putting the occupant's privacy at risk. In contrast, the disclosed device 100 and related techniques limit the information associated with an occupant 106 that is made available to a visitor 108.

Accordingly, the smart intercom device 100 comprises a QR code 102 corresponding to an intercom list 116 as a whole, or a separate QR code 102 is utilized for each occupant 106 on the intercom list 116. Thus, each occupant 106 on the intercom list 116 creates a profile on the corresponding software application, which is then linked to an individual QR code 102. Thus, visitors 108 can contact a specified occupant 106 on the intercom list 116 via their individual QR code 102.

Generally, a “quick response” code or “QR code” 102 may be a matrix barcode and a type of machine-readable code that contains information (i.e., information pertaining to a specific occupant's name, address, and phone number). A typical QR code 102 may use four standardized encoding modes (numeric, alphanumeric, byte/binary, and kanji) to efficiently store data.

As explained above, QR codes 102 can encode personal data and other information. A QR code 102 can be used to initiate contact with a specified occupant 106. Further, two-way communication using QR codes 102 can also improve security.

Furthermore, the smart intercom device 100 allows a visitor 108 to contact and communicate with a specified occupant 106 from an intercom list 116. Specifically, a smart phone 104 of a visitor 108 is used to scan a QR code 102 that is associated with a specified occupant 106 from an intercom list 116. The QR code 102 then allows the visitor 108 to communicate with the specified occupant 106. Specifically, the QR code 102 and software application displays on the visitor's smart phone 104, an interface 118 for contacting the specified occupant 106. The visitor 108 can then choose how to contact the specified occupant 106, either calling, messaging, and/or sending an alert in the form of an audible sound or noise. The call, message, or alert is then sent and the visitor 108 is now able to communicate with the specified occupant 106 to determine if they are home and/or can come pick up a package or open the door 112.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Further, computer storage media (devices) include RAM, ROM, EEPROM, CD-ROM, solid state drives (“SSDs”) (i.e., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention 100 may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, etc.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention 100 can be hosted in a cloud environment.

Generally, an apartment, office, home, or other building 110 displays a two dimensional barcode (or QR code 102) that corresponds to an intercom list 116. Other types of scannable codes could also be used in the same manner as the QR code 102. The QR code 102 is uniquely associated with the intercom list 116. More specifically, the QR code 102 can uniquely identify a specified occupant 106 from the intercom list 116. One QR code 102 could be linked to the intercom list 116 in general or a separate QR code 102 would be listed for each occupant 106 on the intercom list 116. In this manner, by scanning the QR code 102, a software application executing on a smart phone 104 can retrieve the necessary information for communicating with a specified occupant 106 on the intercom list 116.

Furthermore, a database of QR codes 102 can be maintained (i.e., on a server system 404 with which a smart phone 104 can communicate). Each of the QR codes 102 in the database can be associated with a unique occupant 106 on the intercom list 116. The database can also store contact information for each of the occupants 106 on the intercom list 116. In such cases, when a visitor 108 scans a QR code 102 with a smart phone 104, a software application on the smart phone 104 can access the database to identify whether the QR code 102 is defined in the database. If the QR code 102 is defined in the database, the contact information associated with the QR code 102 can be used to contact the specified occupant 106 on the intercom list 116.

Additionally, each QR code 102 represents a unique identifier. When the QR code 102 is scanned, the unique identifier for the QR code 102 can be determined and used to query a data structure to obtain the contact information associated with the QR code 102. Once obtained, the account information can be used to contact the specified occupant 106 on the intercom list 116.

Furthermore, the present invention enables a visitor 108 to contact an occupant 106 on the intercom list 116 by simply scanning a QR code 102 that has been associated with the intercom list 116 or more specifically, scanning a QR code 102 that has been associated with a specified occupant 106 from the intercom list 116. In some embodiments, the present invention can provide a website or other software application where occupants 106 from the intercom list 116 can input their contact information to receive a QR code 102 that is unique to them and which can be displayed outside their apartment, office, home, or other building for visitors 108, in lieu of an intercom. Visitors 108 can then contact a specified occupant 106 from the intercom list 116 when visiting or dropping a package off. For example, in response to receiving an occupant's contact information, the software application can generate an association between the contact information and a QR code 102. The associated QR code 102 can then be provided to the visitor 108 who is trying to contact the specified occupant 106. For example, the QR code 102 can be displayed outside of or in the lobby of an apartment complex, office, home, or other building 110, to allow the QR code 102 to be visible to visitors 108.

Additionally, the QR code 102 requests can be timestamped, as well as may specify a unit number of the occupant 106, a floor of the occupant 106, or a name of the occupant 106. Based on the specified information, a centralized computer system 400 searches through the stored occupant 106 information to identify the occupant 106 associated with the visitor's request. Once the occupant 106 is identified, the centralized computer system 400 may pull up additional information associated with the identified occupant 106 that is stored in occupant information of the centralized data storage 400. This additional information may include, for example, a phone number of the occupant 106, a name of the occupant 106, a time period when the occupant 106 accepts requests, a primary means of communication, a secondary means of communication, an indication to not participate in such communications if there is a no-call list, a neighbor who has agreed to receive the occupant's requests when the occupant 106 is not available, an indication that the occupant 106 is away or on vacation, etc. This additional information may be used by the centralized computer system 400 to facilitate communication between the visitor 108 and the occupant 106.

Further, the centralized computer system 400 may store information associated with the visitor 108 who made the request. This information may be stored under visitor 108 information within the centralized data storage of the centralized computer system 400. This information may include, for example, a name of the visitor 108, a phone number of the visitor 108, the type of request made (i.e., did the visitor 108 request access to an entrance of a facility), reason for the request (i.e., delivery, social visit, etc.), affiliations (i.e., FedEx employee), etc. This information may be used by the centralized computer system 400 to facilitate communication between the visitor 108 and the occupant 106.

In one embodiment, the visitor interface 118 generated by the QR code 102 may require that the visitor 108 authenticates themselves. Authentication may include requiring the visitor 108 to enter their name, phone number, reason for visiting, etc. This information may then be provided to the centralized computer system 400 for storage. Once a visitor 108 is authenticated, they may be provided an authorization code by the centralized computer system 400. When a visitor 108 makes a request to communicate with an occupant 106, this authorization code may be provided to the occupant device. The occupant device may use the authorization code to access information associated with the visitor 108, such as, for example, the visitor's name, phone number, and/or reason for visiting.

Specifically, the disclosed device 100 and related techniques may allow a visitor 108 to lookup a unit number or a floor of the occupant 106 without revealing the name of the occupant 106 and/or a phone number of the occupant 106. Similarly, the disclosed device 100 and related techniques may allow a visitor 108 to enter a name of an occupant 106 without revealing the unit number, floor, and/or phone number of the occupant 106. The disclosed device 100 and related techniques accomplishes this, in part, through use of a software application and QR code 102 by which the device 100 facilitates communication between the visitor 108 and the occupant 106.

Additionally, the disclosed device 100 further protects the privacy and safety interests of an occupant 106 by optionally requiring that the visitor 108 be within a predetermined boundary before they are permitted to contact the occupant 106. For example, the disclosed device 100 may require that the visitor 108 be within 5 meters of the facility 110 before they can contact an occupant 106 of the facility 110 through the QR code 102. The boundary may be set by a manager of the facility 110. When a visitor 108 makes attempts to contact an occupant 106, a global positioning system (GPS) unit of the smart device 104 will send a location of the device 100 to the disclosed smart intercom device 100. The disclosed device 100 determines, based on the received location, whether the visitor device 104 is within the predetermined boundary. If a visitor 108 is too far away (i.e., outside of the predetermined boundary), they may be notified that they are not within the predetermined boundary when attempting to contact an occupant 106 and prevented from contacting the occupant 106. Similarly, in other embodiments, the disclosed device 100 further protects the privacy and safety interests of the occupant 106 by requiring that the occupant 106 is within a predetermined boundary before a visitor 108 is able to contact them.

Furthermore, the disclosed device 100 further protects the privacy and safety interests of an occupant 106 by allowing the occupant 106 to choose the method by which they are contacted by the visitor 108. For example, an occupant 106 may choose to permit a visitor 108 to contact them through a notification or a text message but may prevent contact through a voice call or through a video call. Where contact is made through a voice call or a video call, the visitor 108 will not be provided a phone number of the occupant 106. However, in some implementations, where contact is made through a voice call or a video call, the occupant 106 may receive the phone number of the visitor 108 or other identifying information of the visitor 108 such as their name.

Additionally, the disclosed device 100 further protects the privacy and safety interests of an occupant 106 by allowing the occupant 106 to choose the method by which they (the occupant 106) request additional information from a visitor 108. For example, an occupant 106 may choose to initiate a conversation with the visitor 108 to obtain additional information through a notification, a text message, a voice call, or a video call.

Further, the disclosed device 100 also prevents a visitor 108 from entering a facility 110 or a unit of a facility when an occupant 106 of the facility 110 cannot, or would prefer not to, physically provide access to the visitor 108.

Generally, the disclosed device 100 eliminates most of the costs associated with a traditional intercom system 114 and reduces the time needed to setup an intercom system 114. By using a virtual intercom system, there is no need to spend the time and cost installing a physical intercom system 114 in the facility 110. Such traditional systems 114 are expensive and require difficult installation as numerous wires may need to be run throughout the facility 110 on which the intercom 114 is being installed. The disclosed device 100 removes the need for such traditional systems 114 by using a mobile or software application in communication with a QR code 102 and a visitor's smart device 104.

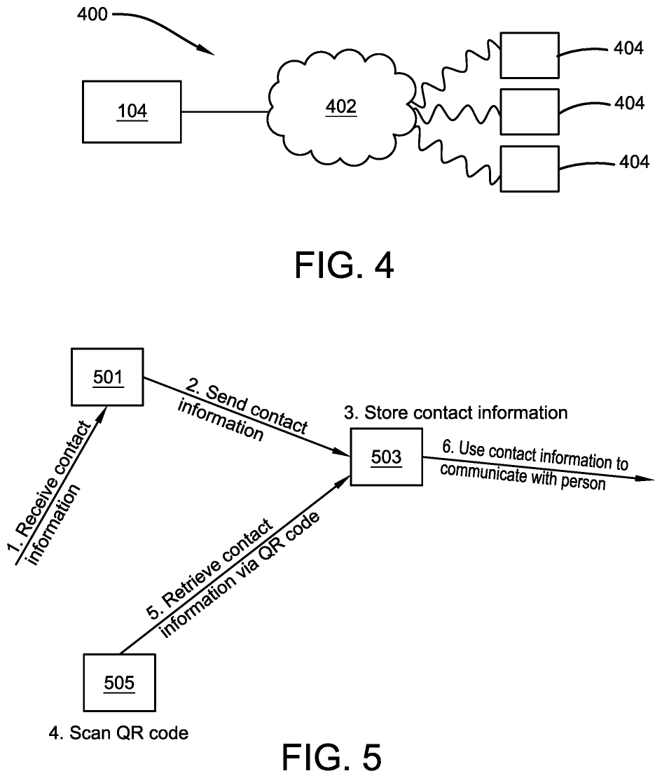

As shown in FIG. 4, an example centralized computer environment 400 includes a mobile computing device (i.e., smart phone 104) which may typically be a smart phone 104 having a camera with which a QR code 102 can be scanned. The smart phone 104 is interconnected via a network 402 with multiple server systems 404. The server systems 404 can represent the systems where an occupant's contact information is stored.

The specific manner in which information is transferred is not essential to the invention. The network 402 typically will be the internet although other networks can also be employed. For example, in a typical implementation, the mobile computing device 104 will communicate with one or more of the server systems 404 using a Wi-Fi or cellular (i.e., 4G) connection. Also, although this specification will primarily refer to using a smart phone 104, any mobile computing device capable of performing the described functionality could also be used (i.e., a tablet).

As shown in FIG. 5, a process 500 of creating an association between a QR code 102 and an occupant's contact information is disclosed. An occupant 106 from the intercom list 116 desiring to receive a QR code 102 inputs their contact information (step 502) in a web page or software application 501. Contact information can include an occupant's name, address, unit number, and telephone number, as well as any other information necessary to contact the occupant 106. Additional information can also be input such as the occupant's work location, work title, picture, etc. Such information can be useful for providing an interface 118 such as a visitor interface when a QR code 102 is scanned.

Once the contact information is input to the web page or software application 501, the contact information can then be sent to a server system 503 (step 504). The QR code 102 can then be generated/associated with the contact information (step 506). Once the occupant 106 receives the QR code 102, it can be displayed (i.e., electronically or by printing the QR code 102) where visitors 108 can view and scan it to gain contact information and to communicate with the specified occupant 106 from the intercom list 116. Accordingly, a visitor 108 scans the QR code 102 using a smart phone 505 and gains access to an intercom interface 118 on their smart phone 505 (step 508). The scanned QR code 102 is then used to retrieve the appropriate contact information (step 510). Finally, the contact information is used to initiate communication between the visitor 108 and the specified occupant 106 from the intercom list 116, that is associated with the scanned QR code 102 (step 512).

Further, the occupant device and visitor device 104 wirelessly communicate with the one or more doors 112 of a facility 110 and of an individual unit. The wireless communication may take place through cellular, Bluetooth, near-field communication (NFC), radio-frequency identification (RFID), and/or Wi-Fi, etc., to allow a visitor 108 access if requested and approved by the occupant 106.

Accordingly, once the visitor 108 scans the QR code 102 located on a door 112 of the front entrance via the camera of their smart device 104, the visitor device is directed to a website or a digital distribution platform to access a software application or a Wi-Fi network that allows a visitor 108 to communicate with an occupant 106 of the facility 110. In some embodiments, the QR code 102 also allows a visitor 108 to request access to an entrance of a facility 110.

The occupant device and the visitor device 104 may each be a computing device, i.e., a mobile phone, a smart phone, a personal digital assistant (PDA), a tablet computer, a laptop computer, or a desktop computer, etc.

In yet another embodiment, the smart intercom device 100 comprises a plurality of indicia 300. The QR code 102 of the device 100 may include advertising, a trademark, or other letters, designs, or characters, printed, painted, stamped, or integrated into the QR code 102, or any other indicia 300 as is known in the art. Specifically, any suitable indicia 300 as is known in the art can be included, such as but not limited to, patterns, logos, emblems, images, symbols, designs, letters, words, characters, animals, advertisements, brands, etc., that may or may not be smart device, QR code, or brand related.

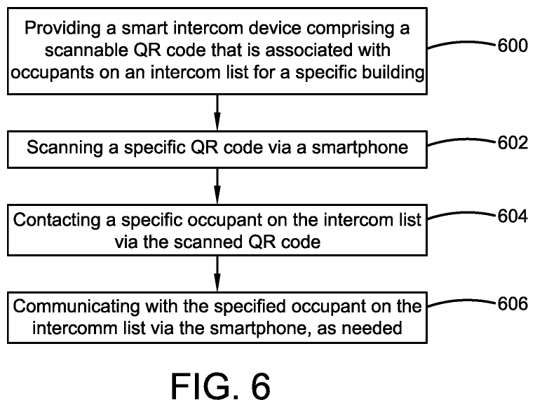

FIG. 6 illustrates a flowchart of the method of scanning a QR code to communicate with an occupant on an intercom list. The method includes the steps of at 600, providing a smart intercom device comprising a scannable QR code that is associated with occupants on an intercom list for a specific building, office, home, apartment, etc. The method also comprises at 602, scanning a specific QR code via a smart phone. Further, the method comprises at 604, contacting a specific occupant on the intercom list via the scanned QR code. Finally, the method comprises at 606, communicating with the specified occupant on the intercom list via the smart phone, as needed.

Certain terms are used throughout the following description and claims to refer to particular features or components. As one skilled in the art will appreciate, different visitors may refer to the same feature or component by different names. This document does not intend to distinguish between components or features that differ in name but not structure or function. As used herein “smart intercom device”, “intercom device”, and “device” are interchangeable and refer to the smart intercom device 100 of the present invention.

Notwithstanding the forgoing, the smart intercom device 100 of the present invention can be of any suitable size and configuration as is known in the art without affecting the overall concept of the invention, provided that it accomplishes the above stated objectives. One of ordinary skill in the art will appreciate that the smart intercom device 100 as shown in FIGS. 1-6 is for illustrative purposes only, and that many other sizes and shapes of the smart intercom device 100 are well within the scope of the present disclosure. Although the dimensions of the smart intercom device 100 are important design parameters for visitor convenience, the smart intercom device 100 may be of any size that ensures optimal performance during use and/or that suits the visitor's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart intercom device that provides a visitor with a means for communicating with an
occupant on an intercom list, the smart intercom device comprising:
a QR code;
a software application; and
a smart phone;
wherein the QR code is displayed outside a building;
wherein the QR code corresponds to an intercom list of the building and its occupants;
wherein a visitor scans the QR code to access an interface of the intercom list of the building; and
further wherein the visitor can communicate with a selected occupant from the intercom list while maintaining privacy and safety of the selected occupant.

2. The smart intercom device of claim 1, wherein the building includes a multi-unit dwelling, an apartment, a house, a townhouse, a condominium, a duplex, other residential facilities, an office, a gated area, or other commercial facilities.

3. The smart intercom device of claim 2, wherein the visitor includes a delivery person, a potential client, a client, a potential employee, an employee, a potential work associate, a work associate, or a social guest.

4. The smart intercom device of claim 3, wherein the QR code corresponds to the intercom list as a whole.

5. The smart intercom device of claim 3, wherein the QR code corresponds to a specific occupant from the intercom list.

6. The smart intercom device of claim 5, wherein each occupant on the intercom list creates a profile on the corresponding software application.

7. The smart intercom device of claim 6, wherein the profile is linked to an individual QR code.

8. The smart intercom device of claim 7, wherein the smart phone of a visitor is used to scan the individual QR code.

9. The smart intercom device of claim 8, wherein once the individual QR code is scanned, the interface is displayed on the visitor's smart phone.

10. The smart intercom device of claim 9, wherein the visitor can choose how to contact the specified occupant, either calling, messaging, or sending an alert.

11. The smart intercom device of claim 10, wherein the call, message, or alert is then sent to the specified occupant and the visitor is now able to communicate with the specified occupant to determine if they are home or can come pick up a package or open the building's door.

12. A method of creating an association between a QR code and an occupant's contact information and then using this association to communicate with the occupant, the method comprising the following steps:
inputting an occupant's contact information;
sending the occupant's contact information to a server system;
generating a QR code with the occupant's contact information; and
displaying the QR code at a building, such that visitors can view and scan the QR code for an interface of the building's intercom list.

13. The method of claim 12, wherein the QR code is uniquely associated with the building's intercom list.

14. The method of claim 13, wherein the QR code uniquely identifies a specified occupant from the intercom list.

15. The method of claim 14, wherein a database of QR codes is maintained on a server system with which a smart phone can communicate.

16. The method of claim 15, wherein a software application on the smart phone can access the database to identify whether a QR code request is defined in the database.

17. The method of claim 16, wherein the QR code requests can be timestamped, and identify a unit number, a floor, or a name of a specified occupant.

18. The method of claim 17, wherein a visitor needs to authenticate themselves on the interface or be within a predetermined boundary before contacting the specified occupant.

19. The method of claim 18, wherein the visitor only lookups a unit number or a floor of the occupant without revealing name of the occupant; or looks up the name of the occupant without revealing the unit number, the floor, or phone number of the occupant.

20. A method of scanning a QR code to communicate with an occupant on an intercom list, the method comprising the following steps:
providing a smart intercom device comprising a scannable QR code that is associated with
occupants on an intercom list for a specific building, office, home, or apartment;
scanning a specific QR code via a smart phone;
contacting a specific occupant on the intercom list via the scanned QR code; and
communicating with the specified occupant on the intercom list via the smart phone, as needed.
